(19) United States
(12) Patent Application Publication
(10) Pub. No.: US 2025/0335485 A1
(43) Pub. Date: Oct. 30, 2025

(54) AUTOMATIC IDENTIFICATION OF RELATED, DIGITAL COMMUNICATIONS

(71) Applicant: Intuit, Inc., Mountain View, CA (US)

(72) Inventors: Itay MARGOLIN, Petah Tikva (IL); Eilon SHEETRIT, Tel Aviv (IL); Ido FARHI, Herzliya (IL)

(21) Appl. No.: 18/650,934

(22) Filed: Apr. 30, 2024

(51) Int. Cl. G06F 16/901; G06N 7/01

(52) U.S. Cl. CPC G06F 16/3347; G06F 16/9024; G06N 7/01

(57) ABSTRACT

Certain aspects of the disclosure provide a method for automatically identifying related communications, comprising: tokenizing a new communication from a first sender into a first plurality of tokens; identifying a plurality of communications associated with the first sender; for each respective communication: generating a self-attention data element comprising a plurality of attention values determined based on the first plurality of tokens associated with the new communication and a second plurality of tokens associated with the respective communication; determining a first plurality of features from the self-attention data element; and processing, with a machine learning (ML) model trained to identify related communications, the first plurality of features and to generate a score indicating a relatedness of the respective communication to the new communication; and determining communication(s) of the plurality of communications are related to the new communication based on each of the communication(s) having a score above a threshold.

### FIELD

Aspects of the present disclosure relate to digital communications.

### DESCRIPTION OF RELATED ART

Digital communication is ubiquitous in modern society and takes place, for example, on a computer, a smartphone, tablet computer, smart wearable device, and on other mobile devices. Written digital communication includes the digital exchange of information, ideas, and/or messages through written text, such as through emails, text messages, instant messages, social media interactions, and others.

Electronic mail (or email) is a type of written digital communication involving sending messages from a user to one or more recipients via a network, such as the Internet. Email includes both browser-based electronic mail, such as Gmail® and YAHOO! Mail®, and non-browser-based electronic mail accessed through an email client, such as Microsoft® Outlook® for Office 365®. Email has proven to be one of the most widely used ways to communicate in today's digital world due to its ability to communicate messages and data in a fast, inexpensive, and reliable way.

For example, email provides an efficient way of exchanging messages, thereby allowing for real-time feedback and/or conversations at any given time. This efficient form of communication helps users and/or businesses respond to questions, customer inquiries, and/or the like promptly, thereby reducing wait times for all involved. Email also helps to eliminate costly delays caused by using traditional communication methods, such as mail postal services. Further, with email, messages may be delivered in moments to anyone, anywhere in the world where there exists an internet connection. This wide reach makes email an invaluable tool that allows messages to be sent easily around the world.

While email communication provides the aforementioned advantages, such communication also has its downsides. For example, statistics show that on average, a user may receive approximately 120 emails a day, which can negatively impact concentration, productivity, and time management. Moreover, email can easily be used perniciously, such as through spam, phishing, and other email misuse.

While some email is just informational, often email solicits a response from a user receiving the email. In cases where a body of the email includes sufficient information to inform the user about what is requested and/or what the email is in reference to, then the user may effectively respond. As an illustrative example, an email received by a user may recite:
“Hi, User. Thank you for providing me with the quote (Quote #1234) for my office remodel at 111 Mulberry Street. The price quoted is a little higher than I was expecting to pay. Would you be able to offer a discount on the $5,000 quote price?”
   Inclusion of the quote number, the house address, and the estimated quote price in the body of the email may provide the user with sufficient information to effectively respond to the question posed by the sender of the email.

In cases where the body of the email, soliciting the response, does not include sufficient information, but is connected to one or more other emails in the user's digital mailbox, (e.g., via an email chain, which is a collection of forwarded or linked emails (e.g., linked via use of a “reply” functionality, a “reply all” functionality, a “forward” functionality, and/or other email functionality)), then the user may determine a context for the received email based on the connected email communication(s). The user may effectively respond based on this additional context. As an illustrative example, an email received by a user may recite:
“Hi, User. Would you be able to offer a discount on the provided quote?”
   Based on this email alone, the user may not know what quote the sender of the email is referring to and much less how to effectively respond to the question posed by the sender of the email. However, the email may be connected to two prior communications between the sender and the user. For example, the email may be an email responding to an email previously sent (“previous email”) by the user to the sender of this email (e.g., for example, via use of a “reply,” “reply all,” and/or “forward” functionality). The previous email may include information about the quote the sender is referring to. Specifically, example information in the previous email may include the quote number, the house address associated with the quote, and/or the estimated quote price. Using this information from the previous communication, the user may effectively respond to the sender's question.

In cases where the body of the email, soliciting the response, does not include sufficient information and is not connected to one or more other emails in the user's digital mailbox, then the user may not be able to effectively respond, at least without gathering some additional information. As an illustrative example, an email received by a user may recite:
“Would you be able to offer a discount on the provided quote?”
   This email may also not be connected to any other emails previously sent and/or received by the user and included in the user's digital mailbox. Based on this email alone, the user may not know what quote the sender of the email is referring to and much less how to effectively respond to the question posed by the sender.

As such, while email communication is generally beneficial, in some cases, email communication may be ineffective when (1) contextless digital communications are utilized for communication and/or (2) such communications are sent without using “reply,” “reply all,” forward,” and/or other similar functionality used to link the communications to previous communications for additional context. As used herein, a contextless digital communication may refer to a communication lacking information about circumstances that form the setting for the communication such that the communication can be fully understood and assessed by a receiver of the communication. Example contextless digital communications may include contextless emails, such as the email described above reciting only “Would you be able to offer a discount on the provided quote?”

Contextless emails may present a technical problem for effective digital communication. For example, unlike a real-time phone call or face-to-face conversation where an immediate response is common, email is an asynchronous communication form in which a period of time may pass before a new communication in a conversation is received. A user receiving the new communication, after the period of time, may have trouble recalling what conversation the email is related to, much less the context of the conversation. Accordingly, if the new communication also fails to include this context, then the user may have difficulty responding to the new communication. For example, without additional information, the user may respond incorrectly and/or may simply ignore the new communication if the user cannot understand the sender's intention behind sending the new communication.

As an illustrative example, a first user may send a first email to a second user at 10:00 AM Monday morning, and the second user may respond to the first email by sending a second email at 5:00 PM Tuesday evening, such that there exists a 31 hour difference between the first email and the second email. The first and second emails may be digital communications used to discuss dinner plans between the first user and the second user. If the second email is a contextless email simply reciting that “6:00 PM is good for me,” first user receiving this second email may not be able to recall that the second email is referring to dinner plans the first user has with the second user. An inability to understand the second email, without additional information, may lead to first user ignoring the second message, missing the dinner plans, and/or the like.

Although the above technical problems are described with respect to email communications, similar technical problems may be realized for other written digital communications, such as text messages, instant messages, and/or for social media interactions, to name a few.

### SUMMARY

Certain aspects provide a method for automatically identifying related communications, comprising: tokenizing a new communication from a first sender into a first plurality of tokens; identifying a plurality of communications associated with the first sender; for each respective communication of the plurality of communications associated with the first sender: generating a self-attention data element comprising a plurality of attention values determined based on the first plurality of tokens associated with the new communication and a second plurality of tokens associated with the respective communication; determining a first plurality of features from the self-attention data element; and processing, with a machine learning (ML) model trained to identify related communications, the first plurality of features and to generate a score indicating a relatedness of the respective communication to the new communication; and determining one or more communications of the plurality of communications are related to the new communication based on each of the one or more communications having a score above a threshold

Certain aspects provide a method of training an ML model to automatically identify related communications, comprising: obtaining a plurality of training data instances based on a plurality of communications organized in a graph; for each training data instance of the plurality of training data instances: generating a self-attention data element comprising a plurality of attention values for a plurality of tokens associated with the training data instance, wherein the plurality of tokens are from a first communication and a second communication; determining a first plurality of features from the self-attention data element; training the ML model to classify the first communication and the second communication as related communications or unrelated communications and thereby generate a classification output using the first plurality of features; and using a loss function to determine a loss value based on the classification output; and modifying one or more parameters of the ML model based on the loss value.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system implementing a machine learning model trained to automatically identify related digital communications.

FIGS. 2A-2B depict an example workflow used to automatically identify communications related to contextless emails received by a user.

FIGS. 3A-3B depict an example workflow used to train a machine learning model to automatically identify communications related to contextless emails received by a user.

FIG. 4 depicts an example method for automatically identifying related digital communications.

FIG. 5 depicts an example method of training a machine learning model to automatically identify related digital communications.

FIG. 6 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

To effectively respond to a contextless digital communication, such as an email, and thus address the aforementioned issues, in some cases, a user may seek to identify previous communications associated with the contextless digital communication. For example, a user receiving a contextless email (that is not also linked to any previous email communications) may attempt to identify previous email communication(s) related to the contextless email (referred to herein as “related communications” and/or “related digital communications”) to help the user better understand the circumstances surrounding the contextless email. Identifying related communication(s) may be a technically challenging task, and in some cases, may prove to be unsuccessful in helping the user understand and assess the contextless email.

For example, a user's digital mailbox (including its inbox, sent items, deleted items, archived items, etc.) may include hundreds or thousands of emails, given an average user may receive approximately 120 emails per day. Methods for identifying related communication(s) may include manually and/or automatically searching the user's digital mailbox (e.g., including hundreds or thousands of emails) for (1) previously-communicated email(s) from the same sender as the contextless email and/or (2) previously-communicated email(s) using one or more of the same tokens (e.g., where a token is an individual character, word, sub-word, phrase, or even larger linguistic unit in text) as the contextless email.

Manually sifting through large amounts of emails to identify digital communication(s) from the same sender and/or that utilize similar token(s) may be cumbersome, time consuming, and/or generally impractical for sufficiently large digital mailboxes including a large number of emails. In fact, for digital mailboxes containing large amounts of emails, the technical problem may be intractable when considering manual approaches.

Further, automatically (e.g., with little or no direct human control) sifting through large amounts of emails to identify digital communication(s) from the same recipient and/or that utilize similar token(s) may also be time consuming and/or may use significant processing power and resources. In some cases, where multiple contextless emails are received, and thus automatic methods are used to identify related digital communication(s) for each contextless email, available resources for performing this identification may be insufficient.

In some cases, numerous emails may be identified as being associated with the contextless email. As such, a user may need to manually scan the language included in each of these emails to identify which email(s) are, in fact, related to the contextless email. Scanning each email may be inefficient and again, where the number of emails to review is sufficiently large, may not be reasonably performed by a human. Further, repetitive scanning of a large number of emails may also cause a user to lose focus when manually scanning each email, thereby leading, in some cases, to the user inadvertently missing an email that is, in fact, related to the contextless email.

Accordingly, conventional methods for identifying related digital communications may not be effective for understanding and/or responding to contextless digital communications.

Embodiments described herein overcome the technical problems of conventional approaches and improve upon the state of the art by introducing techniques for the automatic identification of related digital communications, such as email communications. For example, when a contextless email is received by a user, embodiments described herein may initially use a graph to identify digital communications associated with a same sender as the contextless email. The graph may provide a representation of relationships that exist between at least two digital communications, each previously sent to the user and included in the user's digital mailbox. The graph may be used to initially narrow down the pool of potential digital communications (e.g., in the user's digital mailbox) that may be related to the contextless email by efficiently identifying digital communications with a same sender as the contextless email.

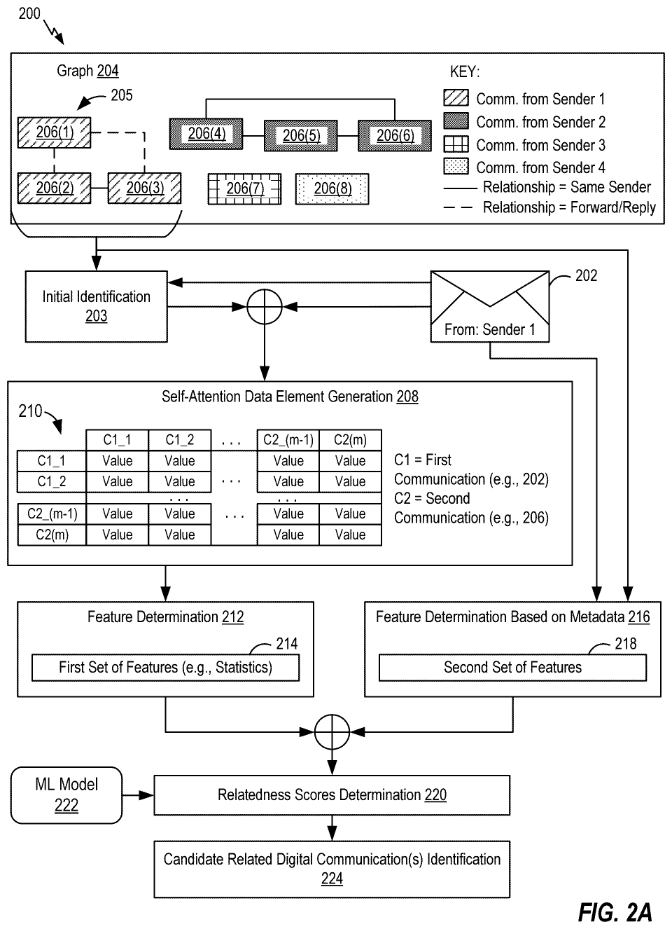

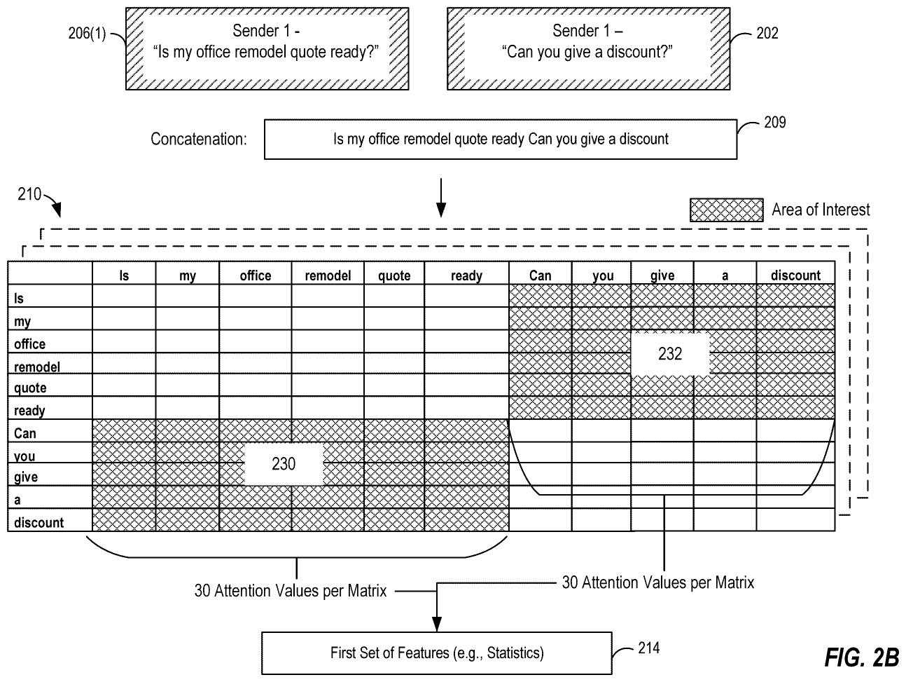

Embodiments described herein then determine a correlation between each digital communication in the pool of communications and the contextless email (e.g., a first correlation between the contextless email and the first digital communication, a second correlation between the contextless email and the second digital communication, etc.). In certain embodiments, the correlation between the contextless email and one of the digital communications is determined by determining a relative correlation between each token in the contextless email (e.g., individual character(s), word(s), sub-word(s), phrase(s), etc. in the contextless email) with respect to each token in the digital communication, and vice versa (e.g., each token in the digital communication with respect to each token in the contextless email). For example, if the contextless email includes tokens “Tomorrow at five works” and the digital communication includes tokens “What time” then a (1) a first correlation between “Tomorrow” and “What” may be determined, (2) a second correlation between “Tomorrow” and “time” may be determined, and so forth for each token in the contextless email (and vice versa). In certain embodiments, the correlation between two tokens is determined as a correlation value. In certain embodiments, the correlation between two tokens is determined as an “attention value,” and multiple attention values determined for tokens in the contextless email and one of the digital communications are included in a self-attention data element, as described in detail below with respect to FIGS. 2A-2B.

Large correlation values determined for tokens in the contextless email and one of the digital communications may effectively indicate that the specific digital communication (e.g., for which the correlation values were determined), as a whole, is likely related to the contextless email. On the other hand, small correlation values may effectively indicate that the specific digital communication (e.g., for which the correlation values were determined), as a whole, is not likely related to the contextless email.

For each digital communication in the pool of digital communications, a first set of features (e.g., statistics) may be determined based on the correlation values determined for the respective digital communication (e.g., when compared to the contextless email). Optionally, a second set of features may be determined based on metadata associated with the digital communication and the contextless email. The first set of features and, optionally, the second set of features may be provided as input into a machine learning (ML) model trained to identify related digital communications. For example, the ML model may process the features and thereby generate a score indicative of a relatedness of the respective digital communication to the contextless email. This may be performed for each digital communication in the pool of potential digital communications. In certain embodiments, digital communications may be ranked based on their scores, and digital communications within a top percentage of the ranking may be determined to be related to the contextless email and displayed to the user. In certain embodiments, digital communications with a score above a (e.g., configured or preconfigured) threshold may be determined to be related to the contextless email and displayed to the user. Displaying the related digital communications (e.g., emails) to the user may provide the user with additional context needed for understanding, assessing, responding to, and/or taking action based on the contextless email.

Though embodiments herein are described with respect to identifying email(s) (e.g., example digital communication(s)) related to a contextless email received by a user, the techniques described herein may be similarly applied to identify relationships between any type of digital communications, such as chat messages, text messages, social media interactions, and/or the like.

The techniques for identifying related digital communications described herein provide significant technical advantages over conventional solutions, such as an ability to identify related digital communications more efficiently and more accurately, especially in cases where the pool of potential communications that may be related to a contextless digital communication is large (e.g., includes hundreds or thousands of past digital communications). These techniques overcome technical problems of limited data processing capabilities in conventional approaches, as well as low email identification accuracy in cases where a user needs to manually scan each email to identify related communication(s). For example, the techniques described herein may automatically determine a relatedness of past digital communications to a contextless digital communication by considering both (1) the context of each past digital communication (e.g., via use of correlation values) and/or (2) metadata differences between each past digital communication and the contextless digital communication to make a determination, which is unlike conventional approaches where a user manually scans through such communications, and thus provides a technical advantage over those conventional approaches.

Notably, the techniques described herein can improve the functionality of any existing digital communication service, such as an electronic mail service. For example, the techniques may be used to identify digital communication(s) related to a contextless digital communication received via the digital communication service and provide these digital communication(s) to a user of the digital communications service. These digital communication(s) may beneficially provide the user with context that the user may have been previously lacking to effectively respond and/or take action based on the received contextless digital communication. In some cases, the contextless digital communication may concern a critical matter, such as a court hearing the user is required to be present at, work for a potential new client, a deadline for payment to avoid foreclosure on a home, and/or a medical diagnosis for the user, among many other examples. Thus, being able to understand and decipher the contextless digital communication may, in some cases, help to avoid a wide range of bad outcomes related to the user's finances, business, assets, health, and/or legal liability, among others.

### Example System Implementing an ML Model Trained to Automatically Identify Related Digital Communications

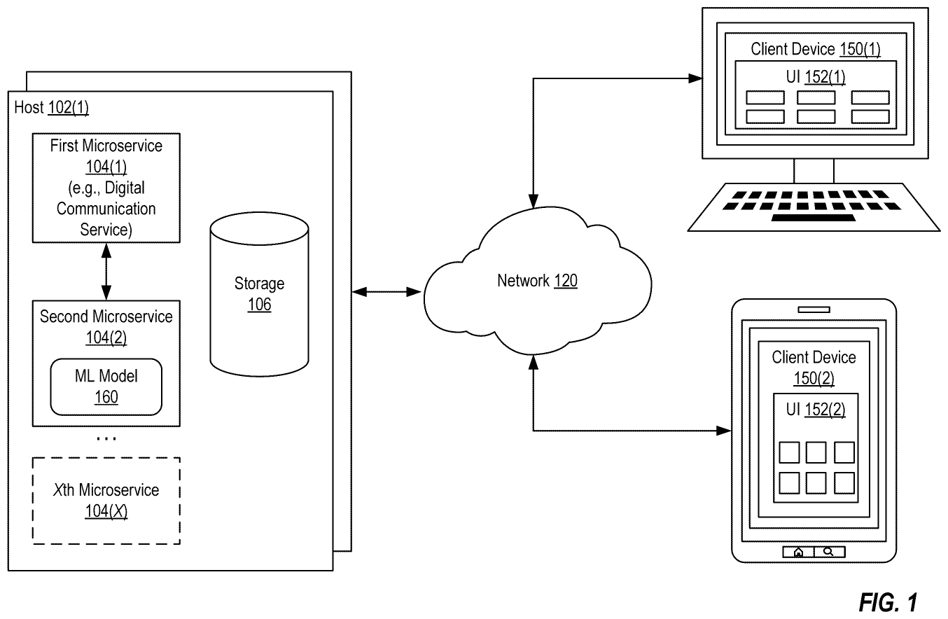

FIG. 1 depicts an example system 100 having an ML model 160 trained to automatically identify related digital communications, deployed for used by a software-defined service (e.g., in some cases, a cloud-native software-defined service), also referred to herein as “a microservice 104.” Microservices 104 are loosely coupled and independently deployable services (or software), which may make up an application. Thus, microservices 104 may enable segmented, granular level functionalities within a larger system infrastructure. It should be understood that the components of system 100 depicted in FIG. 1 and described herein are merely examples and systems with additional, alternative, and/or a fewer number of components may be considered within the scope of this disclosure. For example, a limited field extractor may be implemented as something other than a microservice.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs) 120), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface 152(1), 152(2), respectively, which may be used to communicate with, at least, first microservice 104(1) and second microservice 104(2) using the network 120. For example, communication between client devices 150 and each microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, a first microservice 104(1) and a second microservice 104(2). In some embodiments, the first microservice 104(1) implements a digital communication service. For example, the first microservice 104(1) may implement an electronic mail service, which is any network 120 accessible service that enables users to send, receive, and/or store emails.

In some embodiments, the second microservice 104(2) deploys an ML model 160. Second microservice 104(2) may use ML model 160 to automatically identify one or more digital communications (e.g., such as previously sent and/or received emails) related to a contextless digital communication (e.g., such as an email) received via first microservice 104(1), e.g., the digital communication service. In certain embodiments, second microservice 104(2) generates for display the identified digital communication(s) to provide a user, which received the contextless digital communication, with additional context. For example, the ML model 160 may be used to automatically identify that a previous email reciting “Hi, Jane. Do you want to meet at 17:00 or 18:00 for dinner at XYZ Steakhouse?” is likely related to a contextless email received at first microservice 104(1) reciting “I'll meet you at 18:00.” Second microservice 104(2) generates for display the previous email to help a user more easily determine that the received email is likely referring to dinner reservations the receiver has with Jane at XYZ Steakhouse.

ML model 160 may be any model capable of being applied on a vector. For example, ML model 160 may be a multilayer perception (MLP) model, a support vector machine (SVM), a tree-based model, to name a few. Further, though FIG. 1 depicts only a single ML model 160 being deployed by second microservice 104(2), in certain other aspects, multiple ML models 160, trained to identify related digital communications, may be deployed and used by second microservice 104(2).

Additionally, though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for the Automatic Identification of Related Digital Communications

FIGS. 2A-2B depict an example workflow 200 used to identify digital communications related to contextless digital communications, and more specifically, contextless emails received by a user. For example, as shown in in FIG. 2A, a new digital communication, such as email 202, may be received by a user from a first sender, “Sender 1.” Email 202 may be an email sent from Sender 1 to the user via an electronic mail service (e.g., such as the electronic mail service implemented by first microservice 104(1) in FIG. 1). Email 202 may be an example of a contextless email lacking necessary information about circumstances that form the setting for email 202 such that the user may fully understand the nature of what is being conveyed in email 202.

For example, email 202 may recite “Can you give a discount?” (e.g., as shown in FIG. 2B). Without additional information, the user, receiving email 202, may be unaware of what email 202 relates to, specifically with respect to providing a discount. To adequately respond to email 202, the user may need to acquire additional information regarding the context of email 202.

Workflow 200 may be used to aid the user in acquiring this additional information. For example, workflow 200 includes steps for (1) initial identification 203, (2) self-attention data element generation 208, (3) feature determination 212, (4) feature determination based on metadata 216, (5) relatedness scores determination 220, and (6) candidate related digital communication(s) identification 224, which may be performed to identify communication(s) (e.g., past emails in the user's digital mailbox) related to email 202.

Initial identification 203 may include identifying digital communications (e.g., emails), previously sent to the user, with a same sender as email 202. A graph 204, representing relationships that exist between digital communications previously sent to the user and included in the user's digital mailbox, may be used to perform initial identification 203.

For example, graph 204 may consist of a plurality of nodes (e.g., such as node 205 corresponding to digital digital communication 206(1)) and edges (e.g., shown as solid black and dashed lines in FIG. 2A), where each edge connects one node to another node. Each node may correspond to a digital communication 206 (e.g., shown as eight digital communications 206(1)-(8) in FIG. 2A) previously sent to the user and included in the user's digital mailbox. For example, in graph 204, three nodes may correspond to three digital communications 206(1)-(3) from Sender 1, three nodes may correspond to three digital communications 206(4)-(6) from sender 2, one node may correspond to a digital communication 206(7) from Sender 3, and one node may correspond to a digital communication 206(8) from Sender 4.

Edges may be used in graph 204 to indicate relationships between various node pairs. For example, a first edge in graph 204, represented by a solid black line, may connect a pair of nodes associated with digital communications 206 from the same sender. As shown in FIG. 2A, the nodes associated with digital communications 206(4)-(6), each from sender 2, are connected via solid black line edges.

A second edge in graph 204, represented by a dashed black line, may connect a pair of nodes associated with linked digital communications 206, such as communications linked by way of using “reply” functionality, “reply all” functionality, forward” functionality, and/or other similar functionality provided via the electronic mail service. As shown in FIG. 2A, the nodes associated with digital communications 206(4)-(6), each from Sender 2, are connected via solid black line edges. As shown in FIG. 2A, the nodes associated with digital communications 206(1) and 206(2), each from Sender 1, are connected via a dashed black line edge. In this case, digital communication 206(2) from Sender 1 may be a digital communication that used the “reply,” “reply all,” or “forward” functionality to respond to an intermediate digital communication (not shown in graph 204) (e.g., in time) between digital communication 206(1) and digital communication 206(2) (e.g., digital communication 206(1) may have been sent to the user at a first time, an intermediate digital communication may have been sent by the user at a second time replying to digital communication 206(1), and digital communication 206(2) may have been sent to the user at a third time replying to the intermediate digital communication).

In graph 204, a dashed black line edge may override a solid black line edge. For example, for nodes associated with digital communications 206 from a same sender and which represent linked communications, a dashed black line edge may connect the two nodes instead of a solid black line edge.

It is noted that graph 204 depicted in FIG. 2A is only one example of a graph 204 that may be used during initial identification 203, and other graphs 204 having more or less nodes with more, less, and/or different edges between the nodes may also be used.

Further it is noted that graph 204 depicted in FIG. 2A is an example graph used to show relationships between nodes associated with email communications. In some other example, the graph may represent relationships between nodes associated with other written digital communications, such as text messages, instant messages, and/or for social media interactions, to name a few. In such cases, two digital communications associated with two different nodes in the graph may be connected via a dashed black line edge when one of the two digital communication was created using a “reply to message” functionality, or other similar functionality connecting the two digital communications.

At initial identification 203, the nodes corresponding to digital communications 206(1)-(3) may be identified as communications with at least a same sender as email 202, given digital communications 206(1)-(3) were all previously sent by Sender 1.

Self-attention data element generation 208 may include generating at least one self-attention data element 210 for each digital communication 206 determined to be associated with the same sender as email 202.

A self-attention data element generated for a digital communication 206 may include attention values determined based on (1) tokens included in email 202 and (2) tokens included in the digital communication 206. For example, tokens included in the email 202 and tokens included in the digital communication 206 may be concatenated to form a single vector of concatenated tokens. A self-attention mechanism may be used to generate an attention value for each token in the vector of concatenated tokens with respect to every other token in the vector, including itself (e.g., it may be self-referential). An attention value determined for a first token in the vector with respect to a second token in the vector may indicate a relative correlation between the first token with respect to the second token. A larger attention value may indicate a greater correlation between tokens than a smaller attention value. For instance, an attention value determined for a first token “crazy” with respect to a second token “chicken” may be greater than an attention value determined for the first token “crazy” with respect to a third token “road” in a vector of tokens, given “crazy” is more likely to be referring to/categorizing the “chicken” than the “road.”

In this example, self-attention data element generation 208 may include generating at least three self-attention data elements 210 (although only one self-attention data element 210 is shown in FIG. 2A). A first self-attention data element 210 may be generated to include attention values based on tokens associated with email 202 and tokens associated with digital communication 206(1). A second self-attention data element 210 may be generated to include attention values based on tokens associated with email 202 and tokens associated with digital communication 206(2). A third self-attention data element 210 may be generated to include attention values based on tokens associated with email 202 and associated with digital communication 206(3). For example, email 202 may be tokenized into a plurality of tokens when workflow 200 begins.

FIG. 2B depicts example generation of the first self-attention data element 210 based on tokens associated with email 202 and tokens associated with digital communication 206(1) (e.g., generated during self-attention data element generation 208 in FIG. 2A). For this example, email 202 recites “Can you give a discount?” (as described herein), and thus includes five tokens (e.g., disregarding the question mark). Digital communication 206(1) recites “Is my office remodel quote ready?” and thus includes six tokens (e.g., disregarding the question mark). Email 202 and digital communication 206(1) are both communications from Sender 1.

To generate the first self-attention data element 210, the five tokens associated with email 202 are concatenated with the six tokens associated with digital communication 206(1) to generate a concatenated plurality of tokens 209. For example, concatenated plurality of tokens 209 includes “Is my office remodel quote ready Can you give me a discount.” The concatenated plurality of tokens 209 may then be encoded.

Self-attention is then performed to generate an attention value for each token in the concatenated plurality of tokens 209 with respect to every other token in the concatenated plurality of tokens 209, including itself (e.g., it may be self-referential). Each attention value may indicate a relative correlation between a pair of tokens in the concatenated plurality of tokens 209.

For example, as shown in FIG. 2B, self-attention data element 210 may be a two-dimensional array of cells. Each cell may include an attention value determined for a first token in the concatenated plurality of tokens 209 with respect to a second token in the concatenated plurality of tokens 209 (in some cases, where the first token and the second token are the same). In particular, each row in the self-attention data element 210 may correspond to a token in the concatenated plurality of tokens 209 (e.g., a first row corresponds to token “Is,” a second row corresponds to token “my,” etc.). Further, each column in the self-attention data element 210 may correspond to a token in the concatenated plurality of tokens 209 (e.g., a first column corresponds to token “Is,” a second column corresponds to token “my,” etc.). A first attention value (not shown in FIG. 2B) determined for the first row corresponding to token “Is” and for the first column corresponding to token “Is” may indicate a relative correlation of token “Is” with respect to itself. A second attention value (not shown in FIG. 2B) determined for the first row corresponding to token “Is” and for the second column corresponding to token “my” may indicate a relative correlation of token “Is” and token “my.” Other attention values in self-attention data element 210 may be similarly determined.

A high attention value included in a cell in self-attention data element 210 may indicate a high correlation between tokens associated with the cell. Alternatively, a low attention value included a cell in self-attention data element 210 may indicate a low correlation between tokens associated with the cell. If self-attention data element 210 created for tokens in digital communication 206(1) and email 202 includes a large percentage of high attention values, then the likelihood of digital communication 206(1) being related to email 202 may be higher than if self-attention data element 210 includes a small percentage of high attention values.

Attention values included in self-attention data element 210 shown in FIG. 2B may be estimated for concatenated plurality of tokens 209. To consider different attention values that may be estimated for email 202 and digital communication 206(1), in certain embodiments, more than one self-attention data element may be generated for email 202 and digital communication 206(1). As such, multiple potential estimates of attention values may be considered when determining a relatedness of digital communication 206(1) to email 202. This beneficially helps to reduce uncertainties associated with estimating attention values for pairs of tokens in the concatenated plurality of tokens 209.

Steps shown in FIG. 2B to generate self-attention data element 210 for digital communication 206(1) and email 202 may be similarly performed to generate a self-attention data element 210 for digital communication 206(2) and email 202, as well as to generate a self-attention data element 210 for digital communication 206(3). As such, after performing self-attention data element generation 208 in FIG. 2A, at least three self-attention data elements 210 may be generated.

Workflow 200 then proceeds to perform feature determination 212 and feature determination based on metadata 216.

Feature determination 212 includes determining a first plurality of features 214 from self-attention data element(s) 210 generated for each digital communication 206(1), 206(2), and 206(3). In certain embodiments, the first plurality of features 214 determined for self-attention data element(s) 210 associated with a digital communication 206 may include statistics computed for attention values in the self-attention data element(s) 210. For example, the statistics may include one or more mean values, one or more mode values, one or more median values, one or more maximum values, and/or one or more minimum values, among others, each computed for a subset of attention values in one self-attention data element 210 and/or a subset of attention values included in two or more of the self-attention data elements 210 generated for a digital communication 206.

In certain embodiments, statistics are calculated based on attention values associated with specific areas of interest in the self-attention data element(s) 210 associated with a digital communication 206. An area of interest in a self-attention data element 210 may include an area of cells in the self-attention data element 210 including attention values determined between tokens of the digital communication 206 and tokens of email 202.

For example, as shown in FIG. 2B, areas of interest in self-attention data element 210 may include area 230 and area 232. Area 230 includes attention values for tokens in email 202 with respect to tokens in digital communication 206(1). Area 232 includes attention values for tokens in digital communication 206(1) with respect to tokens in email 202. Statistics computed for attention values in area 230 and/or area 232 in self-attention data element 210 may be computed based on two or more attention values and up to sixty attention values in these areas. In certain embodiments, some statistics are determined for attention values in area 230 separate from statistics determined for attention values in area 232. In certain embodiments, statistics are determined per row and/or per column in self-attention data element 210.

For the example illustrated in FIG. 2A, three sets of first plurality of features 214 may be determined (e.g., one for each of the digital communications 206(1), 206(2), and 206(3)) at feature determination 212.

Feature determination based on metadata 216 includes determining a second plurality of features 218 for each digital communication 206(1), 206(2), and 206(3). The second plurality of features 218 for digital communication 206(1) may be based on metadata associated with digital communication 206(1) and email 202. The second plurality of features 218 for digital communication 206(2) may be based on metadata associated with digital communication 206(2) and email 202. Further, the second plurality of features 218 for digital communication 206(3) may be based on metadata associated with digital communication 206(3) and email 202. In certain embodiments, example metadata associated with each digital communication 206 and/or email 202 may include information about a time when each digital communication 206 and email 202 was sent, such that the second plurality of features 218 include a time difference between when a digital communication 206 was sent and when email 202 was sent. In certain embodiments, example metadata associated with each digital communication 206 and/or email 202 may include information about a number of recipients associated with each digital communication 206 and email 202, such that the second plurality of features 218 include information about a number of recipients common between a digital communication 206 and email 202.

Workflow 200 then proceeds to relatedness score determination 220 where a relatedness score (simply referred to herein as “score”) is determined for each digital communication 206(1), 206(2), and 206(3). For example, to determine the score for digital communication 206(1), first plurality of features 214 and second plurality of features 218 determined for digital communication 206(1) are concatenated to create a concatenated vector of features. An ML model 222 is used to process the concatenated vector of features and generate a score for digital communication 206(1). The score may indicate a relatedness of digital communication 206(1) to email 202. The score may range anywhere between zero and one (including zero and one). A score of zero may indicate that digital communication 206(1) and email 202 are not likely related, while a score of one may indicate that they are likely related. Similar steps may also be used to generate a score for digital communication 206(2) and digital communication 206(3).

In certain embodiments, feature determination based on metadata 216 is optional. As such, in certain embodiments, only a first set of features 214 may be determined for each digital communication 206. Thus, instead of providing a concatenated vector of features as input into the ML model 222, only the first set of features 214, associated with a digital communication 206, may be provided as input into the ML model 222 to generate a score the digital communication 206.

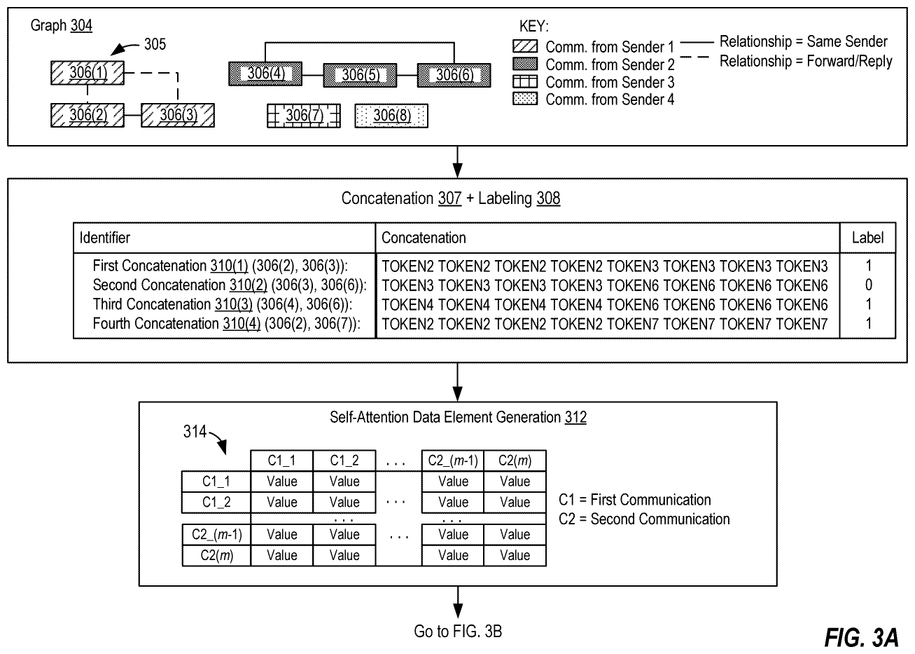

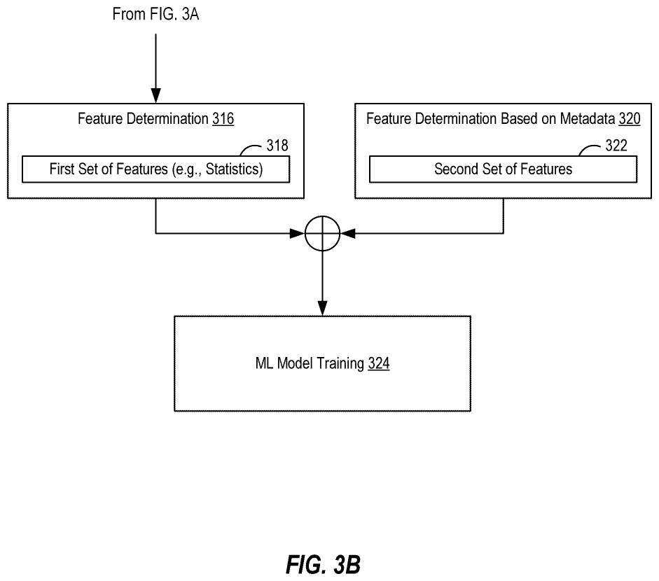

ML model 222 used to generate the scores for relatedness scores determination 220 may be a model trained to identify related digital communications. The model may be a classification model used to perform binary classification. Workflow 300, described and depicted with respect to FIGS. 3A and 3B, may be used to train ML model 222 to perform this classification task. Examples of ML model 222 may an MLP model, an SVM, and/or a tree-based model, to name a few.

After generating the scores for digital communications 206(1), 206(2), and 206(3), workflow 200 proceeds to candidate related communication(s) identification 224 to determine whether digital communication 206(1), digital communication 206(2), and/or digital communication 206(3) are related to email 202. This determination may be made based on the scores determined for each digital communication 206 at relatedness scores determination 220. In certain embodiments, digital communication(s) 206 determined to be related to email 202 are digital communication(s) 206 with scores above a threshold score. For example, if the score for digital communication 206(1) is above a threshold score, then digital communication 206(1) may be determined to be related to email 202.

In certain other embodiments, digital communications 206 are ranked based on their respective scores. Digital communication(s) ranked within a top threshold percentage (e.g., such as top 25% after ranking the digital communications 206) may be identified as communication(s) related to email 202. For example, digital communication 206(1) may have a higher score than digital communication 206(2), and digital communication 206(2) may have a higher score than digital communication 206(3). Accordingly, the communications may be ranked as digital communication 206(1), digital communication 206(2), and digital communication 206(3) (e.g., from highest score to lowest score). For this example, digital communications within a top 40% of the ranking may be identified as digital communication(s) related to email 202. As such, only digital communication 206(1) may be determined to be related to email 202. In other examples, other percentages may be considered.

In certain embodiments, the ranking of scored digital communications 206 may be provided to the user that receives email 202 and/or generated for display on a computing device. In certain embodiments, the related digital communication(s) 206 may be generated for display on a computing device. For example, the language included in email communication(s) may be automatically displayed to the user such that the user is able to review each of the digital communication(s) 206. As an illustrative example, a pop-up may automatically appear on a display device indicating “We believe that this email is related to the email you are currently viewing, is this correct?” and including the identified related email. Display of the digital communication(s) 206 may beneficially provide the user with context that the user may have been previously lacking to effectively respond to email 202 and/or take action based on email 202.

For this example, the displayed digital communication(s) 206 may include information about an office remodel and a price discussed with Sender 1 for the office remodel. As such by displaying the digital communication(s) 206 to the user, the user may determine that the “discount” being referred to in email 202 is referencing an office remodel quote that was previously provided to Sender 1. As such, the user may properly, and efficiently, respond to email 202.

In certain embodiments, after workflow 200 is complete, graph 204 may be updated to include a new node for email 202. Further, new edge(s) may be created among the nodes in graph 204.

As an illustrative example, a first solid black line may be added between the node for email 202 and the node for digital communication 206(1), a second solid black line may be added between the node for email 202 and the node for digital communication 206(2), and a third solid black line may be added between the node for email 202 and the node for digital communication 206(3).

### Example Workflow for Training an ML Model to Automatically Identify Related Digital Communications

FIGS. 3A-3B depict an example workflow 300 used to train an ML model to automatically identify digital communications (e.g., emails) related to contextless digital communications (e.g., contextless emails) received by a user. As shown in FIGS. 3A and 3B, workflow 300 may include steps for (1) generating a plurality of training data instances (e.g., by performing concatenation 307 and labeling 308), (2) self-attention data element generation 312, (3) feature determination 316, (4) feature determination based on metadata 320, and (5) ML model training 324.

As shown in FIG. 3A, generating training data instances to train the ML model may include performing concatenation 307 and labeling 308 based on information obtained from a graph 304. Graph 304 may be the same graph as graph 204 described and depicted with respect to FIG. 2A.

For example, graph 304 may consist of a plurality of nodes (e.g., such as node 305) and edges (e.g., shown as solid black and dashed lines in FIG. 3A). Each node may correspond to a digital communication 306 (e.g., shown as eight digital communications 306(1)-(8) in FIG. 3A) previously sent to a user and included in the user's digital mailbox. A first edge in graph 204, represented by a solid black line, may connect a pair of nodes associated with digital communications 306 from the same sender. A second edge in graph 304, represented by a dashed black line, may connect a pair of nodes associated with linked digital communications 306, such as digital communications linked by way of using “reply” functionality, “reply all” functionality, forward” functionality, and/or other similar functionality.

A training data instance may be generated from information included in graph 304 by first selecting two digital communications 306 (e.g., a first digital communication 306 and a second digital communication 306) from graph 304. The digital communications 306 may be selected at random. The first digital communication 306 may include a first plurality of tokens and the second digital communication may include a second plurality of tokens. The first plurality of tokens and the second plurality of tokens may be concatenated to generate a plurality of tokens associated with the training data instance.

For example, in FIG. 3A, digital communication 306(2) and digital communication 306(3) may be randomly selected from graph 304 to form a first training data instance. Tokens from digital communication 306(2) and tokens from digital communication 306(3) may be concatenated to form first concatenation 310(1). Digital communication 306(3) and digital communication 306(6) may be randomly selected from graph 304 to form a second training data instance. Tokens from digital communication 306(3) and tokens from digital communication 306(6) may be concatenated to form second concatenation 310(1). Further, similar steps may be taken to form third concatenation 310(3) for digital communication 306(4) and digital communication 306(6), as well as fourth concatenation 310(4) for digital communication 306(2) and digital communication 306(7).

Labeling 308 includes adding a meaningful and informative label to each concatenation 310 associated with each training data instance to provide context such that the ML model can learn from it. For example, labeling 308 may include labeling each concatenation 310 with a label indicating whether or not the respective concatenation 310 includes tokens for related digital communications 306 (e.g., whether tokens included in the concatenation 310 come from digital communications 306 that are related). For example, a label of “1” may indicate that the respective concatenation 310 includes tokens for related digital communications 306 while a label of “0” may indicate that the respective concatenation 310 does not includes tokens for related digital communications 306. Determining whether a concatenation for two digital communications 306 includes tokens for related digital communications 306 may be based on edges included in graph 304. For example, if two digital communications 306 associated with a concatenation 310 are connected via an edge (e.g., a solid black line or a dashed black line in graph 304), then the digital communications 306 may be related and a label of “1” may be added to the concatenation 310. Otherwise, a label of “0” may be added to the concatenation 310.

Based on the edges included in graph 304 in the example illustrated in FIG. 3, concatenations 310(1), 310(3), and 310(4) may be given a label of “1” (e.g., indicating that digital communications 306 associated with concatenations 310(1), 310(3), and 310(4) are related per graph 304). Further, a label of “0” may be given to concatenation 310(2) (e.g., indicating that digital communications 306 associated with concatenation 310(2) are not related per graph 304).

As used herein, a training data instance may include a training input and a training output. A training output for each training data instance may include the label assigned to the concatenation 310 associated with the respective training data instance during labeling 308.

Workflow 300 then proceeds to self-attention data element generation 312 where at least one self-attention data element 314 is created for each of the training data instances. In this example, self-attention data element generation 312 may include generating at least four self-attention data elements 314 (although only one self-attention data element 314 is shown in FIG. 3A). A first self-attention data element 314 may be generated to include attention values based on tokens associated with concatenation 310(1). A second self-attention data element 314 may be generated to include attention values based on tokens associated with concatenation 310(2). A third self-attention data element 314 may be generated to include attention values based on tokens associated with concatenation 310(3). Further, a fourth self-attention data element 314 may be generated to include attention values based on tokens associated with concatenation 310(4).

Workflow 300 then proceeds to perform feature determination 316 and feature determination based on metadata 320.

Feature determination 316 includes determining a first set of features 318 from self-attention data element(s) 314 generated for each concatenation 310 (e.g., for each training data instance). In certain embodiments, the first set of features 318 determined for self-attention data element(s) 314 associated with a concatenation 310 may include statistics computed for attention values in the self-attention data element(s) 314. For example, the statistics may include a mean value, a mode value, a median value, a maximum value, and/or a minimum value, among others, computed for a subset of attention values in one self-attention data element 314 and/or a subset of attention values included in two or more of the self-attention data elements 314 generated for a concatenation 310.

In certain embodiments, statistics are calculated based on attention values associated with specific areas of interest in the self-attention data element(s) 314 associated with a concatenation 310. An area of interest in a self-attention data element 314 may include an area in the self-attention data element 314 including attention values between tokens of a first digital communication 306 and a second digital communication 306 associated with the concatenation 310 (e.g., associated with the training data instance).

Feature determination based on metadata 320 includes determining a second set of features 322 for each concatenation 310(1), 310(2), 310(3), and 310(4). The second set of features 322 for concatenation 310(1) may be based on metadata associated with digital communication 306(2) and digital communication 306(3). The second set of features 322 for concatenation 310(2) may be based on metadata associated with digital communication 306(3) and digital communication 306(6). The second set of features 322 for concatenation 310(3) may be based on metadata associated with digital communication 306(4) and digital communication 306(6). Further, the second set of features 322 for concatenation 310(4) may be based on metadata associated with digital communication 306(2) and digital communication 306(7).

Workflow 300 then proceeds to ML model training 324 where an ML model is trained to classify digital communications 306 as related digital communications or unrelated digital communications. For example, the ML model training 324 may include training the ML model to generate a classification output for each concatenation 310, based on a the first set of features and the second set of features determined for each concatenation 310.

As an illustrative example, the first set of features and the second set of features determined for concatenation 310(1), associated with the first training data instance, may be concatenated to generate a concatenated vector of features associated with the first training data instance. The ML model may process the concatenated vector of features and generate a classification output for digital communication 306(2) and digital communication 306(3) associated with concatenation 310(1) and the first training data instance.

The classification output may indicate whether digital communication 306(2) and digital communication 306(3) are related digital communications or unrelated digital communications. For example, the ML model may provide a classification output of “1” when digital communication 306(2) and digital communication 306(3) are predicted to be related digital communications. Alternatively, the ML model may provide a classification output of “0” when digital communication 306(2) and digital communication 306(3) are predicted to be unrelated digital communications. This classification output may then be compared to the label assigned to concatenation 310(1) (e.g., during labeling 308). Similar steps may be performed to also compare the classification outputs generated for concatenations 310(2), 310(3), and 310(4) to the label assigned to concatenations 310(2), 310(3), and 310(4), respectively.

In certain embodiments, evaluating the similarity of each predicted classification output, generated for each concatenation 310 associated with each training data instance, to an expected classification output (e.g., a label) associated with the respective concatenation 310 is performed using a loss function. The loss function is a mathematical function that measures how well the ML model is able to predict the desired output, and more specifically, a label associated with each concatenation 310 associated with each training data instance. A loss value determined for each classification output using the loss function may be minimized (or equal to zero) when the predicted classification output for a concatenation 310 matches the label assigned to the concatenation 310/training data instance.

### Example Method for Automatically Identifying Related Communications

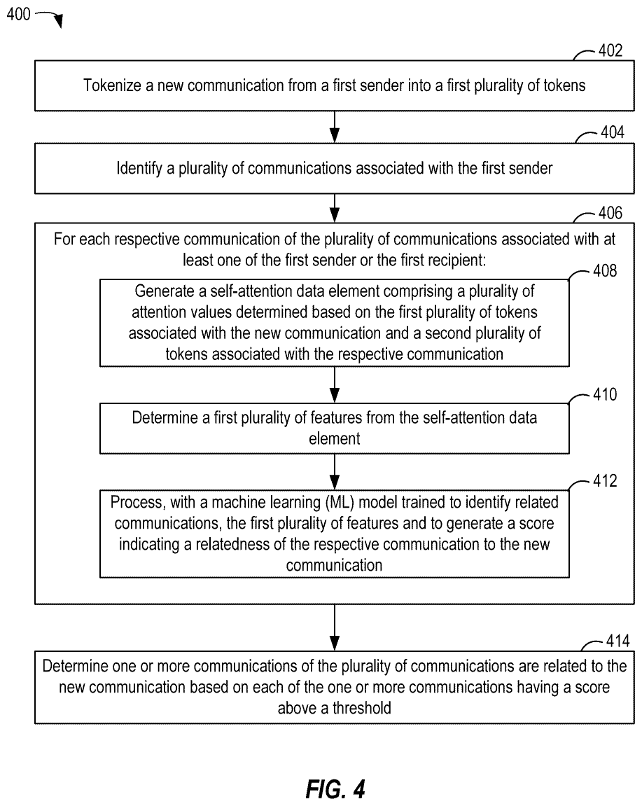

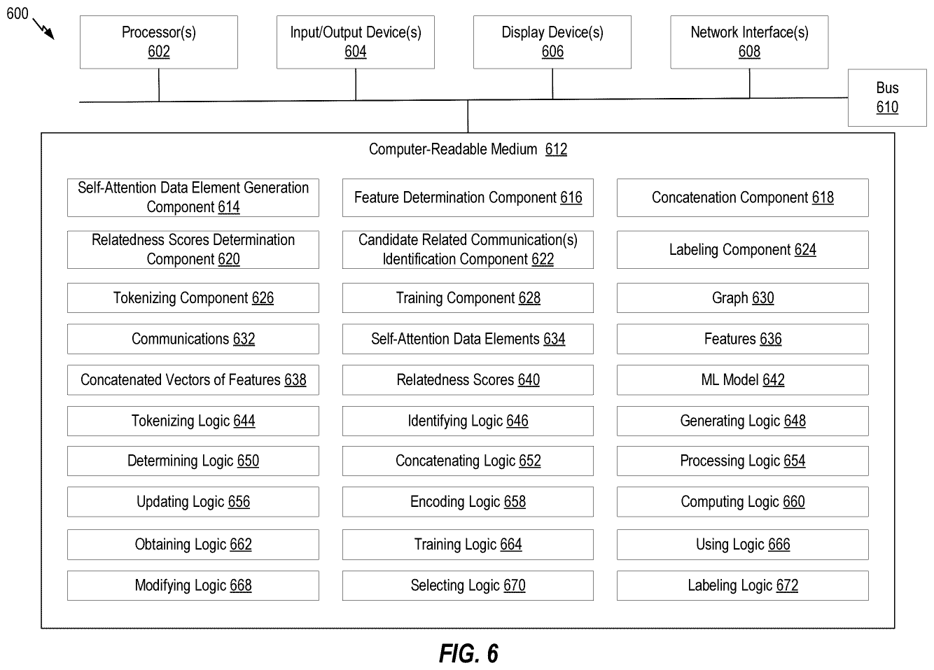

FIG. 4 depicts an example method 400 for automatically identifying related communications (e.g., such as email communications). Method 400 may be performed by one or more processor(s) of a computing device, such as processor(s) 602 of processing system 600 described below with respect FIG. 6.

Method 400 begins, at block 402, with tokenizing a new communication from a first sender into a first plurality of tokens.

Method 400 proceeds, at block 404, with identifying a plurality of communications associated with the first sender.

Method 400 proceeds, at block 406, with performing steps at blocks 408-412 for each respective communication of the plurality of communications associated with the first sender.

At block 408, method 400 proceeds with generating a self-attention data element comprising a plurality of attention values determined based on the first plurality of tokens associated with the new communication and a second plurality of tokens associated with the respective communication.

Generating a self-attention data element for each communication associated with the first sender may eliminate the need for a user to manually scan and review each communication determined to have a same first sender as the new communication, as done in conventional methods to identify related communications. Accordingly, the overall process for identifying related communications may be more efficient compared to conventional methods and, in some cases, more result in more accurate identification of related communications given the related communications are based on analytical methods, as opposed to subjective decision making by the user.

At block 410, method 400 proceeds with determining a first plurality of features from the self-attention data element.

At block 412, method 400 proceeds with processing, with an ML model trained to identify related communications, the first plurality of features and to generate a score indicating a relatedness of the respective communication to the new communication.

Method 400 proceeds, at block 414, with determining one or more communications of the plurality of communications are related to the new communication based on each of the one or more communications having a score above a threshold.

In certain embodiments, method 400 further includes generating for display on a computing device the one or more communications.

In certain embodiments, method 400 further includes, for each respective communication of the plurality of communications associated with the first sender: determining a second plurality of features based on metadata associated with the new communication and the respective communication; and concatenating the first plurality of features and the second plurality of features to create a concatenated vector of features. In certain embodiments, processing at block 414 includes processing, with the ML model, the concatenated vector of features.

In certain embodiments, the second plurality of features include at least one of: a time difference between the new communication and the respective communication, or a number of recipients common between the new communication and the respective communication.

In certain embodiments, identifying at block 404 includes identifying the plurality of communications using a graph. The graph may include a plurality of nodes. Each of the plurality of nodes may correspond to a communication including a second plurality of tokens. One or more first pairs of nodes in the plurality of nodes may be connected via a first edge in the graph based on each node in each of the one or more first pairs of nodes corresponding to a communication from a same sender. One or more second pairs of nodes in the plurality of nodes may be connected via a second edge in the graph based on each of the one or more second pairs of nodes corresponding to related communications.

Identifying a plurality of communications associated with the first sender using the graph beneficially helps to reduce the pool of communications that may be related to the new communication. Further, using a graph, already including information about related communications, beneficially helps to speed up such identification, especially in cases where a user's digital mailbox includes a large number of past communications. Performing this reduction at the beginning of method 400 beneficially reduces the amount of communications that need to be assessed, thereby saving time, resources, and/or processing power to identify related communications.

In certain embodiments, method 400 further includes updating the graph to include: a new node corresponding to the new communication, and a new first edge connecting the new node to each node of the plurality of nodes corresponding to the plurality of communications associated with the first sender.

In certain embodiments, generating the self-attention data element includes: concatenating the first plurality of tokens associated with the new communication and the second plurality of tokens associated with the respective communication to generate a concatenated plurality of tokens; encoding the concatenated plurality of tokens; generating the self-attention data element comprising a two-dimensional array of cells; and determining an attention value for each cell in the self-attention data element. In certain embodiments, each row in the self-attention data element corresponds to a respective token of the concatenated plurality of tokens, each column in the self-attention data element corresponds to a respective token of the concatenated plurality of tokens. In certain embodiments, the attention value is between the respective token corresponding to the row where the cell is positioned in the self-attention data element and the respective token corresponding to the column where the cell is positioned in the self-attention data element.

In certain embodiments, determining the first plurality of features from the self-attention data element includes computing one or more statistics for a subset of the plurality of attention values and a second subset of the plurality of attention values. The subset of attention values may include the attention values determined for the cells in the self-attention data element corresponding to both a first token of the concatenated plurality of tokens associated with the first plurality of tokens associated with the new communication and a second token of the concatenated plurality of tokens associated with the second plurality of tokens associated with the respective communication.

Note that FIG. 4 is just one example of a method, and other methods including fewer, additional, or alternative steps are possible consistent with this disclosure.

### Example Method for Training an ML Model to Automatically Identify Related Communications

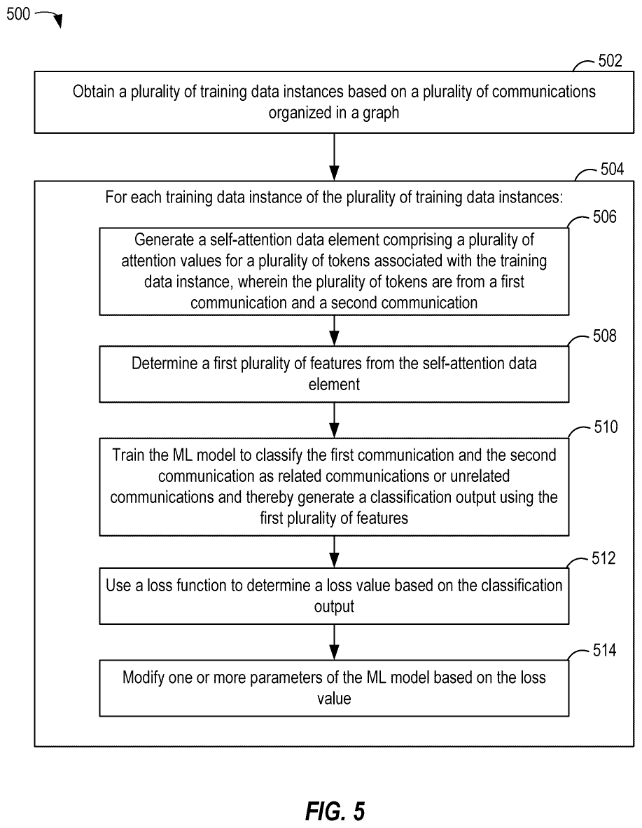

FIG. 5 depicts an example method 500 for training an ML model to automatically identify related communications (e.g., such as email communications). Method 500 may be performed by one or more processor(s) of a computing device, such as processor(s) 602 of processing system 600 described below with respect FIG. 6.

Method 500 begins, at block 502, with obtaining a plurality of training data instances based on a plurality of communications organized in a graph.

Method 500 proceeds, at block 504, with performing steps at blocks 508-514 for each training data instance of the plurality of training data instances.

At block 506, method 500 proceeds with generating a self-attention data element comprising a plurality of attention values for a plurality of tokens associated with the training data instance, wherein the plurality of tokens are from a first communication and a second communication.

At block 508, method 500 proceeds with determining a first plurality of features from the self-attention data element.

At block 510, method 500 proceeds with training the ML model to classify the first communication and the second communication as related communications or unrelated communications and thereby generate a classification output using the first plurality of features.

At block 512, method 500 proceeds with using a loss function to determine a loss value based on the classification output.

At block 514, method 500 proceeds with modifying one or more parameters of the ML model based on the loss value.

In certain embodiments, method 500 further includes, for each training data instance of the plurality of training data instances: determining a second plurality of features based on metadata associated with the first communication and the second communication; and concatenating the first plurality of features and the second plurality of features to generate a concatenated vector of features associated with the training data instance. In certain embodiments, training at block 510 includes training the ML model to classify the first communication and the second communication as the related communications or the unrelated communications and thereby generate the classification output using the concatenated vector of features generated for the training data instance.

In certain embodiments, the second plurality of features include at least one of: a time difference between the first communication and the second communication, or a number of recipients common between the first communication and the second communication.

In certain embodiments, the graph includes a plurality of nodes. Each of the plurality of nodes may correspond to a single communication of the plurality of nodes. One or more first pairs of nodes in the plurality of nodes may be connected via a first edge in the graph based on each node in each of the one or more first pairs of nodes corresponding to a communication from a same sender. One or more second pairs of nodes in the plurality of nodes may be connected via a second edge in the graph based on each of the one or more second pairs of nodes corresponding to related communications.

In certain embodiments, obtaining the plurality of training data instances based on the plurality of communications organized in a graph, at block 502, includes, for each training data instance, randomly selecting the first communication and the second communication from the plurality of communications. The first communication may include a first plurality of tokens and the second communication may include a second plurality of tokens. Further, for each training data instance: concatenating the first plurality of tokens and the second plurality of tokens to generate the plurality of tokens associated with the training data instance; and labeling the training data instance with a label based on whether the first edge or the second edge exists between a first node of plurality of nodes in the graph corresponding to the first communication and a second node of the plurality of nodes in the graph corresponding to the second communication.

In certain embodiments, the label classifies the first communication and the second communication as the related communications or the unrelated communications.

In certain embodiments, generating the self-attention data element at block 506 includes: encoding the plurality of tokens associated with the training data instance; generating the self-attention data element comprising a two-dimensional array of cells; and determining an attention value for each cell in the self-attention data element. Each row in the self-attention data element may correspond to a respective token of the plurality of tokens. Each column in the self-attention data element may correspond to a respective token of the plurality of tokens. The attention value may be between the respective token corresponding to the row where the cell is positioned in the self-attention data element and the respective token corresponding to the column where the cell is positioned in the self-attention data element.

In certain embodiments, determining the first plurality of features from the self-attention data element at block 508 includes computing one or more statistics for a subset of the plurality of attention values and a second subset of the plurality of attention values. The subset of attention values may include the attention values determined for the cells in the self-attention data element corresponding to both a first token of the plurality of tokens associated with the first communication and a second token of the plurality of tokens associated with the second communication.

In certain embodiments, the loss function is a binary cross entropy loss function.

Note that FIG. 5 is just one example of a method, and other methods including fewer, additional, or alternative steps are possible consistent with this disclosure.

### Example Processing System for Automatically Identifying Related Communications Using Graph Objects

FIG. 6 depicts an example processing system 600 configured to perform various aspects described herein, including, for example, method 400 as described above with respect to FIG. 4 and/or method 500 as described above with respect to FIG. 5.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes a self-attention data element generation component 614, a feature determination component 616, a concatenation component 618, a relatedness scores determination component 620, a candidate related communication(s) identification component 622, a labeling component 624, a tokenizing component 626, a training component 628, a graph 630, communications 632, self-attention data elements 634, features 636, concatenated vectors of features 638, relatedness scores 640, a machine learning model 642, tokenizing logic 644, identifying logic 646, generating logic 648, determining logic 650, concatenating logic 652, processing logic 654, updating logic 656, encoding logic 658, computing logic 660, obtaining logic 662, training logic 664, using logic 666, modifying logic 668, selecting logic 670, and labeling logic 672.

In certain embodiments, tokenizing logic 644 includes logic for tokenizing a new communication from a first sender into a first plurality of tokens.

In certain embodiments, identifying logic 646 includes logic for identifying a plurality of communications associated with the first sender using a graph.

In certain embodiments, generating logic 648 includes logic for generating a self-attention data element comprising a plurality of attention values determined based on the first plurality of tokens associated with the new communication and the second plurality of tokens associated with the respective communication. In certain embodiments, generating logic 648 includes logic for generating for display on a computing device the one or more communications. In certain embodiments, generating logic 648 includes logic for generating the self-attention data element comprising a two-dimensional array of cells. In certain embodiments, generating logic 648 includes logic for generating a self-attention data element comprising a plurality of attention values for a plurality of tokens associated with the training data instance, wherein the plurality of tokens are from a first communication and a second communication.

In certain embodiments, determining logic 650 includes logic for determining a first plurality of features from the self-attention data element. In certain embodiments, determining logic 650 includes logic for determining a second plurality of features based on metadata associated with the new communication and the respective communication. In certain embodiments, determining logic 650 includes logic for determining one or more communications of the plurality of communications are related to the new communication based on each of the one or more communications having a score above a threshold. In certain embodiments, determining logic 650 includes logic for determining an attention value for each cell in the self-attention data element, the attention value being between the respective token corresponding to the row where the cell is positioned in the self-attention data element and the respective token corresponding to the column where the cell is positioned in the self-attention data element. In certain embodiments, determining logic 650 includes logic for determining a second plurality of features based on metadata associated with the first communication and the second communication.

In certain embodiments, concatenating logic 652 includes logic for concatenating the first plurality of features and the second plurality of features to create a concatenated vector of features. In certain embodiments, concatenating logic 652 includes logic for concatenating the first plurality of tokens associated with the new communication and the second plurality of tokens associated with the respective communication to generate a concatenated plurality of tokens. In certain embodiments, concatenating logic 652 includes logic for concatenating the first plurality of features and the second plurality of features to generate a concatenated vector of features associated with the training data instance.

In certain embodiments, processing logic 654 includes logic for processing, with an ML model trained to identify related communications, the concatenated vector of features and to generate a score indicating a relatedness of the respective communication to the new communication.

In certain embodiments, updating logic 656 includes logic for updating the graph to include: a new node corresponding to the new communication and a new first edge connecting the new node to each node of the plurality of nodes corresponding to the plurality of communications associated with the first sender.

In certain embodiments, encoding logic 658 includes logic for encoding the concatenated plurality of tokens.

In certain embodiments, computing logic 660 includes logic for computing one or more statistics for a subset of the plurality of attention values and a second subset of the plurality of attention values, wherein the subset of attention values comprise the attention values determined for the cells in the self-attention data element corresponding to both a first token of the concatenated plurality of tokens associated with the first plurality of tokens associated with the new communication and a second token of the concatenated plurality of tokens associated with the second plurality of tokens associated with the respective communication.

In certain embodiments, obtaining logic 662 includes logic for obtaining a plurality of training data instances based on a plurality of communications organized in a graph.

In certain embodiments, training logic 664 includes logic for training the ML model to classify the first communication and the second communication as related communications or unrelated communications and thereby generate a classification output using the concatenated vector of features generated for the training data instance.

In certain embodiments, using logic 666 includes logic for using a loss function to determine a loss value based on the classification output.

In certain embodiments, modifying logic 668 includes logic for modifying one or more parameters of the ML model based on the loss value.

In certain embodiments, selecting logic 670 includes logic for randomly selecting the first communication and the second communication from the plurality of communications, wherein the first communication comprises a first plurality of tokens and the second communication comprises a second plurality of tokens.

In certain embodiments, labeling logic 672 includes logic for labeling the training data instance with a label based on whether the first edge or the second edge exists between a first node of plurality of nodes in the graph corresponding to the first communication and a second node of the plurality of nodes in the graph corresponding to the second communication.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:

Clause 1: A method, comprising: tokenizing a new communication from a first sender into a first plurality of tokens; identifying a plurality of communications associated with the first sender; for each respective communication of the plurality of communications associated with the first sender: generating a self-attention data element comprising a plurality of attention values determined based on the first plurality of tokens associated with the new communication and a second plurality of tokens associated with the respective communication; determining a first plurality of features from the self-attention data element; and processing, with a machine learning (ML) model trained to identify related communications, the first plurality of features and to generate a score indicating a relatedness of the respective communication to the new communication; and determining one or more communications of the plurality of communications are related to the new communication based on each of the one or more communications having a score above a threshold.

Clause 2: The method of Clause 1, further comprising generating for display on a computing device the one or more communications.

Clause 3: The method of any one of Clauses 1-2, further comprising: for each respective communication of the plurality of communications associated with the first sender: determining a second plurality of features based on metadata associated with the new communication and the respective communication; and concatenating the first plurality of features and the second plurality of features to create a concatenated vector of features, wherein processing, with the ML model, the first plurality of features comprises processing, with the ML model, the concatenated vector of features.

Clause 4: The method of Clause 3, wherein the second plurality of features comprise at least one of: a time difference between the new communication and the respective communication, or a number of recipients common between the new communication and the respective communication.

Clause 5: The method of any one of Clauses 1-4, wherein identifying the plurality of communications comprises identifying the plurality of communications using a graph, wherein: the graph comprises a plurality of nodes, each of the plurality of nodes corresponds to a communication comprising a second plurality of tokens, one or more first pairs of nodes in the plurality of nodes are connected via a first edge in the graph based on each node in each of the one or more first pairs of nodes corresponding to a communication from a same sender, and one or more second pairs of nodes in the plurality of nodes are connected via a second edge in the graph based on each of the one or more second pairs of nodes corresponding to related communications.

Clause 6: The method of Clause 5, further comprising updating the graph to include: a new node corresponding to the new communication, and a new first edge connecting the new node to each node of the plurality of nodes corresponding to the plurality of communications associated with the first sender.

Clause 7: The method of any one of Clauses 1-6, wherein generating the self-attention data element comprises: concatenating the first plurality of tokens associated with the new communication and the second plurality of tokens associated with the respective communication to generate a concatenated plurality of tokens; encoding the concatenated plurality of tokens; generating the self-attention data element comprising a two-dimensional array of cells, wherein: each row in the self-attention data element corresponds to a respective token of the concatenated plurality of tokens, each column in the self-attention data element corresponds to a respective token of the concatenated plurality of tokens; and determining an attention value for each cell in the self-attention data element, the attention value being between the respective token corresponding to the row where the cell is positioned in the self-attention data element and the respective token corresponding to the column where the cell is positioned in the self-attention data element.

Clause 8: The method of Clause 7, wherein: determining the first plurality of features from the self-attention data element comprises computing one or more statistics for a subset of the plurality of attention values and a second subset of the plurality of attention values, and the subset of attention values comprise the attention values determined for the cells in the self-attention data element corresponding to both a first token of the concatenated plurality of tokens associated with the first plurality of tokens associated with the new communication and a second token of the concatenated plurality of tokens associated with the second plurality of tokens associated with the respective communication.

Clause 9: A method of training a machine learning (ML) model, comprising: obtaining a plurality of training data instances based on a plurality of communications organized in a graph; for each training data instance of the plurality of training data instances: generating a self-attention data element comprising a plurality of attention values for a plurality of tokens associated with the training data instance, wherein the plurality of tokens are from a first communication and a second communication; determining a first plurality of features from the self-attention data element; training the ML model to classify the first communication and the second communication as related communications or unrelated communications and thereby generate a classification output using the first plurality of features; and using a loss function to determine a loss value based on the classification output; and modifying one or more parameters of the ML model based on the loss value.

Clause 10: The method of Clause 9, further comprising, for each training data instance of the plurality of training data instances: determining a second plurality of features based on metadata associated with the first communication and the second communication; and concatenating the first plurality of features and the second plurality of features to generate a concatenated vector of features associated with the training data instance; wherein training the ML model to classify the first communication and the second communication as the related communications or the unrelated communications and thereby generate the classification output using the first plurality of features comprises training the ML model to classify the first communication and the second communication as the related communications or the unrelated communications and thereby generate the classification output using the concatenated vector of features generated for the training data instance.

Clause 11: The method of Clause 10, wherein the second plurality of features comprise at least one of: a time difference between the first communication and the second communication, or a number of recipients common between the first communication and the second communication.

Clause 12: The method of any one of Clauses 9-11, wherein: the graph comprises a plurality of nodes, each of the plurality of nodes corresponds to a single communication of the plurality of nodes, one or more first pairs of nodes in the plurality of nodes are connected via a first edge in the graph based on each node in each of the one or more first pairs of nodes corresponding to a communication from a same sender, and one or more second pairs of nodes in the plurality of nodes are connected via a second edge in the graph based on each of the one or more second pairs of nodes corresponding to related communications.

Clause 13: The method of Clause 12, wherein obtaining the plurality of training data instances based on the plurality of communications organized in a graph comprises, for each training data instance: randomly selecting the first communication and the second communication from the plurality of communications, wherein the first communication comprises a first plurality of tokens and the second communication comprises a second plurality of tokens; concatenating the first plurality of tokens and the second plurality of tokens to generate the plurality of tokens associated with the training data instance; and labeling the training data instance with a label based on whether the first edge or the second edge exists between a first node of plurality of nodes in the graph corresponding to the first communication and a second node of the plurality of nodes in the graph corresponding to the second communication.

Clause 14: The method of Clause 13, wherein the label classifies the first communication and the second communication as the related communications or the unrelated communications.

Clause 15: The method of any one of Clauses 9-14, wherein generating the self-attention data element comprises: encoding the plurality of tokens associated with the training data instance; generating the self-attention data element comprising a two-dimensional array of cells, wherein: each row in the self-attention data element corresponds to a respective token of the plurality of tokens, each column in the self-attention data element corresponds to a respective token of the plurality of tokens; and determining an attention value for each cell in the self-attention data element, the attention value being between the respective token corresponding to the row where the cell is positioned in the self-attention data element and the respective token corresponding to the column where the cell is positioned in the self-attention data element.

Clause 16: The method of Clause 15, wherein: determining the first plurality of features from the self-attention data element comprises computing one or more statistics for a subset of the plurality of attention values and a second subset of the plurality of attention values, and the subset of attention values comprise the attention values determined for the cells in the self-attention data element corresponding to both a first token of the plurality of tokens associated with the first communication and a second token of the plurality of tokens associated with the second communication.

Clause 17: The method of any one of Clauses 9-16, wherein the loss function comprises a binary cross entropy loss function.

Clause 18: A processing system, comprising: a memory comprising computer-executable instructions; and a processor configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium storing program code for causing a processing system to perform the steps of any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method, comprising:
tokenizing a new communication from a first sender into a first plurality of tokens;
identifying a plurality of communications associated with the first sender;
for each respective communication of the plurality of communications associated with the first sender:
generating a self-attention data element comprising a plurality of attention values determined based on the first plurality of tokens associated with the new communication and a second plurality of tokens associated with the respective communication;
determining a first plurality of features from the self-attention data element; and
processing, with a machine learning (ML) model trained to identify related communications, the first plurality of features and to generate a score indicating a relatedness of the respective communication to the new communication; and
determining one or more communications of the plurality of communications are related to the new communication based on each of the one or more communications having a score above a threshold.

2. The computer-implemented method of claim 1, further comprising generating for display on a computing device the one or more communications.

3. The computer-implemented method of claim 1, further comprising:
for each respective communication of the plurality of communications associated with the first sender:
determining a second plurality of features based on metadata associated with the new communication and the respective communication; and
concatenating the first plurality of features and the second plurality of features to create a concatenated vector of features,
wherein processing, with the ML model, the first plurality of features comprises processing, with the ML model, the concatenated vector of features.

4. The computer-implemented method of claim 3, wherein the second plurality of features comprise at least one of:
a time difference between the new communication and the respective communication, or
a number of recipients common between the new communication and the respective communication.

5. The computer-implemented method of claim 1, wherein identifying the plurality of communications comprises identifying the plurality of communications using a graph, wherein:
the graph comprises a plurality of nodes,
each of the plurality of nodes corresponds to a communication comprising a second plurality of tokens,
one or more first pairs of nodes in the plurality of nodes are connected via a first edge in the graph based on each node in each of the one or more first pairs of nodes corresponding to a communication from a same sender, and
one or more second pairs of nodes in the plurality of nodes are connected via a second edge in the graph based on each of the one or more second pairs of nodes corresponding to related communications.

6. The computer-implemented method of claim 5, further comprising updating the graph to include:
a new node corresponding to the new communication, and
a new first edge connecting the new node to each node of the plurality of nodes corresponding to the plurality of communications associated with the first sender.

7. The computer-implemented method of claim 1, wherein generating the self-attention data element comprises:
concatenating the first plurality of tokens associated with the new communication and the second plurality of tokens associated with the respective communication to generate a concatenated plurality of tokens;
encoding the concatenated plurality of tokens;
generating the self-attention data element comprising a two-dimensional array of cells, wherein:
each row in the self-attention data element corresponds to a respective token of the concatenated plurality of tokens,
each column in the self-attention data element corresponds to a respective token of the concatenated plurality of tokens; and
determining an attention value for each cell in the self-attention data element, the attention value being between the respective token corresponding to the row where the cell is positioned in the self-attention data element and the respective token corresponding to the column where the cell is positioned in the self-attention data element.

8. The computer-implemented method of claim 7, wherein:
determining the first plurality of features from the self-attention data element comprises computing one or more statistics for a subset of the plurality of attention values and a second subset of the plurality of attention values, and
the subset of attention values comprise the attention values determined for the cells in the self-attention data element corresponding to both a first token of the concatenated plurality of tokens associated with the first plurality of tokens associated with the new communication and a second token of the concatenated plurality of tokens associated with the second plurality of tokens associated with the respective communication.

9. A computer-implemented method of training a machine learning (ML) model, comprising:
obtaining a plurality of training data instances based on a plurality of communications organized in a graph;
for each training data instance of the plurality of training data instances:
generating a self-attention data element comprising a plurality of attention values for a plurality of tokens associated with the training data instance, wherein the plurality of tokens are from a first communication and a second communication;
determining a first plurality of features from the self-attention data element;
training the ML model to classify the first communication and the second communication as related communications or unrelated communications and thereby generate a classification output using the first plurality of features;
using a loss function to determine a loss value based on the classification output; and
modifying one or more parameters of the ML model based on the loss value.

10. The computer-implemented method of claim 9, further comprising, for each training data instance of the plurality of training data instances:
determining a second plurality of features based on metadata associated with the first communication and the second communication; and
concatenating the first plurality of features and the second plurality of features to generate a concatenated vector of features associated with the training data instance;
wherein training the ML model to classify the first communication and the second communication as the related communications or the unrelated communications and thereby generate the classification output using the first plurality of features comprises training the ML model to classify the first communication and the second communication as the related communications or the unrelated communications and thereby generate the classification output using the concatenated vector of features generated for the training data instance.

11. The computer-implemented method of claim 10, wherein the second plurality of features comprise at least one of:
a time difference between the first communication and the second communication, or
a number of recipients common between the first communication and the second communication.

12. The computer-implemented method of claim 9, wherein:
the graph comprises a plurality of nodes,
each of the plurality of nodes corresponds to a single communication of the plurality of nodes,
one or more first pairs of nodes in the plurality of nodes are connected via a first edge in the graph based on each node in each of the one or more first pairs of nodes corresponding to a communication from a same sender, and
one or more second pairs of nodes in the plurality of nodes are connected via a second edge in the graph based on each of the one or more second pairs of nodes corresponding to related communications.

13. The computer-implemented method of claim 12, wherein obtaining the plurality of training data instances based on the plurality of communications organized in a graph comprises, for each training data instance:
randomly selecting the first communication and the second communication from the plurality of communications, wherein the first communication comprises a first plurality of tokens and the second communication comprises a second plurality of tokens;
concatenating the first plurality of tokens and the second plurality of tokens to generate the plurality of tokens associated with the training data instance; and
labeling the training data instance with a label based on whether the first edge or the second edge exists between a first node of plurality of nodes in the graph corresponding to the first communication and a second node of the plurality of nodes in the graph corresponding to the second communication.

14. The computer-implemented method of claim 13, wherein the label classifies the first communication and the second communication as the related communications or the unrelated communications.

15. The computer-implemented method of claim 9, wherein generating the self-attention data element comprises:
encoding the plurality of tokens associated with the training data instance;
generating the self-attention data element comprising a two-dimensional array of cells, wherein:
each row in the self-attention data element corresponds to a respective token of the plurality of tokens,
each column in the self-attention data element corresponds to a respective token of the plurality of tokens; and
determining an attention value for each cell in the self-attention data element, the attention value being between the respective token corresponding to the row where the cell is positioned in the self-attention data element and the respective token corresponding to the column where the cell is positioned in the self-attention data element.

16. The computer-implemented method of claim 15, wherein:
determining the first plurality of features from the self-attention data element comprises computing one or more statistics for a subset of the plurality of attention values and a second subset of the plurality of attention values, and
the subset of attention values comprise the attention values determined for the cells in the self-attention data element corresponding to both a first token of the plurality of tokens associated with the first communication and a second token of the plurality of tokens associated with the second communication.

17. The computer-implemented method of claim 9, wherein the loss function comprises a binary cross entropy loss function.

18. A processing system, comprising:
a memory comprising computer-executable instructions; and
a processor configured to execute the computer-executable instructions and cause the processing system to:
tokenize a new communication from a first sender into a first plurality of tokens;
identify a plurality of communications associated with the first sender;
for each respective communication of the plurality of communications associated with the first sender:
generate a self-attention data element comprising a plurality of attention values determined based on the first plurality of tokens associated with the new communication and a second plurality of tokens associated with the respective communication;
determine a first plurality of features from the self-attention data element; and
process, with a machine learning (ML) model trained to identify related communications, the first plurality of features and to generate a score indicating a relatedness of the respective communication to the new communication; and
determine one or more communications of the plurality of communications are related to the new communication based on each of the one or more communications having a score above a threshold.

19. The processing system of claim 18, wherein the processor is further configured to cause the processing system to generate for display on a computing device the one or more communications.

20. The processing system of claim 18, wherein:
the processor is further configured to cause the processing system to, for each respective communication of the plurality of communications associated with the first sender:
determine a second plurality of features based on metadata associated with the new communication and the respective communication; and
concatenate the first plurality of features and the second plurality of features to create a concatenated vector of features, and
to process, with the ML model, the first plurality of features, the processor is configured to cause the processing system to process, with the ML model, the concatenated vector of features.
